(19) United States
(12) Patent Application Publication
(10) Pub. No.: US 2026/0259543 A1
(43) Pub. Date: Sep. 3, 2026

(54) PROCESSING DEVICE, PROGRAM, AND PROCESSING METHOD

(71) Applicant: FANUC CORPORATION, Minamitsuru-gun, Yamanashi (JP)

(72) Inventor: Takayoshi MATSUMOTO, Minamitsuru-gun, Yamanashi (JP)

(21) Appl. No.: 18/994,773

(22) PCT Filed: Aug. 29, 2022
(86) PCT No.: PCT/JP2022/032406

§ 371 Date: Jan. 15, 2025

(51) Int. Cl. G05B 19/402

(52) U.S. Cl. CPC G05B 19/402

(57) ABSTRACT

Provided are a processing device, program, and processing method which can prevent a tool or the like from causing interference when changing the direction of the tool with respect to an inclined plane. A processing device according to an embodiment comprises a calculation unit and a determination unit. The calculation unit calculates one or more combinations of angles at which the tool is a prescribed angle relative to a plane. In order to set the rotational axes to any one of the combinations calculated by the calculation unit, the determination unit determines in which direction and how many times to rotate each of the plurality of rotational axes in accordance with an instruction indicating in which direction to rotate at least one of the rotational axes, and such that the movement amount or movement time of the rotation of the rotation axes is minimum.

### TECHNICAL FIELD

The present invention relates to a processing device, a program, and a processing method.

### BACKGROUND ART

In the case of machining shapes such as holes or pockets in an inclined surface of a workpiece using a machine tool, a program similar to the program used for the XY plane may be desired to be used for the machining.

Techniques for executing such machining include a technique for a numerical control device to define an inclined surface (tilted working plane indexing (G68.2)) and a technique to make the tool perpendicular to the inclined surface (tool axis direction control (G53.1)).

In the case of a machine tool with two rotational axes capable of changing the direction of the tool, there are two sets of angle combinations for the two rotational axes where the tool becomes perpendicular to the inclined surface. Conventional numerical control devices select the one with the smaller movement amount of the rotational axes from these two sets.

### CITATION LIST

### Patent Document

Patent Document 1: PCT International Publication No. WO2011/117915

### DISCLOSURE OF THE INVENTION

### Problems to be Solved by the Invention

However, with the angle combination selected by the numerical control device, interference may occur between the tool and other objects such as workpiece or jig.

A problem to be solved by embodiments of the present invention is to provide a processing device, a program, and a processing method, which are capable of preventing interference between the tool and other objects when changing the direction of the tool with reference to the inclined surface.

### Means for Solving the Problems

The processing device of the embodiment includes a calculation unit and a determination unit. The calculation unit calculates one or more angle combinations for the plurality of rotational axes capable of changing the orientation of the tool, such that the tool forms a predetermined angle with a plane. The determination unit determines a direction and an angle by which each of the plurality of rotational axes is rotated such that the plurality of rotational axes achieve any one of the angle combinations calculated by the calculation unit, in accordance with an instruction indicating a direction by which at least one of the rotational axes is rotated such that a movement amount or movement time of rotation of the rotational axes is minimized.

### Effects of the Invention

The present invention is capable of preventing interference between the tool and other objects when changing the direction of the tool with reference to an inclined surface.

### BRIEF DESCRIPTION OF THE DRAWINGS

FIG. 1 is a block diagram illustrating an example of the main configuration of a numerical control system according to the embodiment and components included in the numerical control system;

FIG. 2 is a flowchart illustrating an example of processing by the processor in FIG. 1;

FIG. 3 is a flowchart illustrating an example of processing by the processor in FIG. 1;

FIG. 4 is a diagram illustrating an example of a table referenced by the second vertical command;

FIG. 5 is a diagram illustrating a first example of the state of the tool and the spindle when the tool is made perpendicular to the inclined surface of the workpiece;

FIG. 6 is a diagram illustrating a second example of the state of the tool and the spindle when the tool is made perpendicular to the inclined surface of the workpiece; and

FIG. 7 is a diagram illustrating an example of the state of the tool and the jig.

### PREFERRED MODE FOR CARRYING OUT THE INVENTION

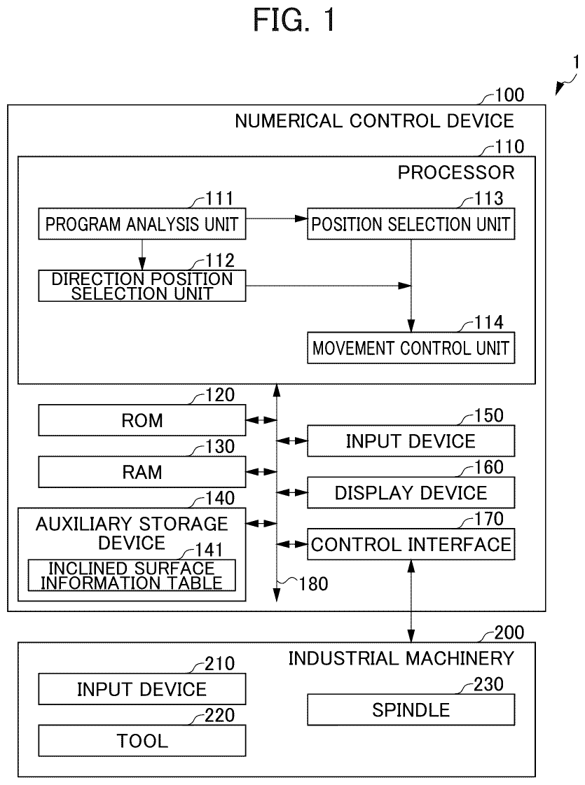

Hereinafter, a numerical control system according to an embodiment will be described with reference to the drawings. In the drawings used in the following description of the embodiments, scales of the respective parts may be appropriately modified. In the drawings used in the following description of the embodiments, configurations may be omitted for description purposes. In the drawings and this specification, the same reference numerals denote similar elements. FIG. 1 is a block diagram illustrating an example of the main configuration of the numerical control system 1 according to the embodiment and components included in the numerical control system 1. The numerical control system 1 includes, as an example, a numerical control device 100 and industrial machinery 200. The numerical control system 1 is an example of a control system.

The numerical control device 100 is a device that executes numerical control on the industrial machinery 200 or the like. The numerical control device 100 includes a function to determine a candidate with the smallest movement amount, from among the candidates for the rotational methods for each rotational axis to make the tool perpendicular to the inclined surface. The numerical control device 100 may be a server device, PC, tablet terminal, or smartphone. The numerical control device 100 includes, as an example, a processor 110, a ROM (read-only memory) 120, a RAM (random-access memory) 130, an auxiliary storage device 140, an input device 150, a display device 160, and a control interface 170. These components are connected by a bus 180 or the like. The numerical control device 100 is an example of a processing device. The perpendicularity of the tool to the inclined surface in this context is an example of a predetermined angle.

The processor 110 is the central part of the computer that executes the necessary computations and control for the operation of the numerical control device 100, executing various computations and processing. The processor 110 may be, for example, a CPU (central processing unit), MPU (micro processing unit), SoC (system on a chip), DSP (digital signal processor), GPU (graphics processing unit), ASIC (application specific integrated circuit), PLD (programmable logic device), or FPGA (field-programmable gate array). Alternatively, the processor 110 may be a combination of a plurality of these components. The processor 110 may also be combined with hardware accelerators. The processor 110 controls various functions of the numerical control device 100, based on programs such as firmware, system software, application software, and NC (numerical control) programs stored in the ROM 120 or the auxiliary storage device 140. The processor 110 executes the processing described later, based on these programs. Parts or all of these programs may be embedded in the circuit of the processor 110. The NC program is a program for numerically controlling the industrial machinery 200.

By executing the above program, the processor 110 functions as a program analysis unit 111, a direction position selection unit 112, a position selection unit 113, and a movement control unit 114.

The program analysis unit 111 analyzes the NC program.

The direction position selection unit 112 determines the rotation method for each rotational axis to make the tool perpendicular to the inclined surface using the direction instructions described later.

The position selection unit 113 determines the rotation method for each rotational axis to make the tool perpendicular to the inclined surface without using the direction instructions described later.

The movement control unit 114 controls the movement of the tool 220 of the industrial machinery 200. The movement control unit 114 controls each rotational axis of the industrial machinery 200.

The ROM 120 and the RAM 130 are the main storage devices of the computer centered around the processor 110. The ROM 120 is a non-volatile memory used exclusively for reading data. The ROM 120 stores firmware, for example, among the above programs. The ROM 120 also stores data used by the processor 110 for various processing. The RAM 130 is memory used for reading and writing data. The RAM 130 is used as a work area for temporarily storing data used by the processor 110 in executing various processing. The RAM 130 is typically volatile memory.

The auxiliary storage device 140 is an auxiliary storage device of the computer centered around the processor 110. The auxiliary storage device 140 may be, for example, EEPROM (electric erasable programmable read-only memory), HDD (hard disk drive), or flash memory. The auxiliary storage device 140 stores system software, application software, and NC programs, for example, among the above programs. The auxiliary storage device 140 stores data used by the processor 110 in executing various processing, data generated by processing in the processor 110, and various settings.

The auxiliary storage device 140 stores an inclined surface information table 141. The inclined surface information table 141 will be described later. The auxiliary storage device 140 is an example of a storage unit.

The input device 150 receives operations by the operator of the numerical control device 100. The input device 150 may be a keyboard, a keypad, a touchpad, a mouse, or a controller, for example. The input device 150 may also be a device for voice input.

The display device 160 displays screens to notify various information to the operator of the numerical control device 100. The display device 160 may be, for example, a liquid crystal display or an organic EL (electro-luminescence) display. A touch panel can also be used as the input device 150 and the display device 160. That is, the display panel included in the touch panel can be used as the display device 160, and the pointing device for touch input included in the touch panel can be used as the input device 150.

The control interface 170 is an interface for the numerical control device 100 to communicate with industrial machinery 200 or the like. The numerical control device 100 controls the industrial machinery 200 or the like through the control interface 170, based on the NC program.

The bus 180 includes a control bus, an address bus, and a data bus, and transmits signals exchanged among the various parts of the numerical control device 100.

The industrial machinery 200 is machinery that operates under numerical control or the like. The industrial machinery 200 may be, for example, a machine tool, a manipulator, a robot arm, or a robot. As an example, the industrial machinery 200 includes an input device 210, a tool 220, and a spindle 230.

The input device 210 receives operations by the operator of the industrial machinery 200. The input device 210 may be a control panel, a keyboard, a keypad, a touchpad, a touch panel, a mouse, or a controller, for example. The input device 210 may also be a device for voice input.

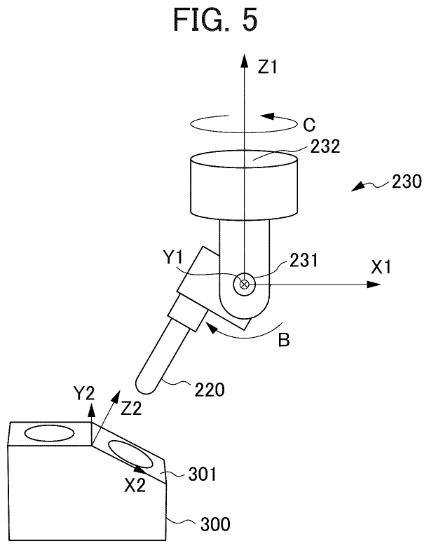

The tool 220 and the spindle 230 will be described with reference to FIG. 5. FIG. 5 is a diagram illustrating a first example of the state of the tool 220 and the spindle 230 when the tool 220 is made perpendicular to the inclined surface 301 of the workpiece 300.

The tool 220 is a tool such as a drill used for machining the workpiece 300.

The spindle 230 can attach the tool 220. The spindle 230 can rotate the tool 220 around the central axis of the tool 220, for example.

The spindle 230 includes a rotational axis 231 and a rotational axis 232. The rotational axis 231 can rotate in the B-axis direction. The spindle 230 can change the direction of the tool 220 by rotating the tool 220 in the B-axis direction around the rotational axis 231. The rotational axis 232 can rotate in the C-axis direction. The spindle 230 can change the direction of the tool 220 by rotating the tool 220 in the C-axis direction around the rotational axis 232. The rotational axes 231 and 232 are typically capable of rotating in both positive and negative directions. The rotational axes 231 and 232 may or may not be restricted in their range of rotation. The spindle 230 may include three or more rotational axes.

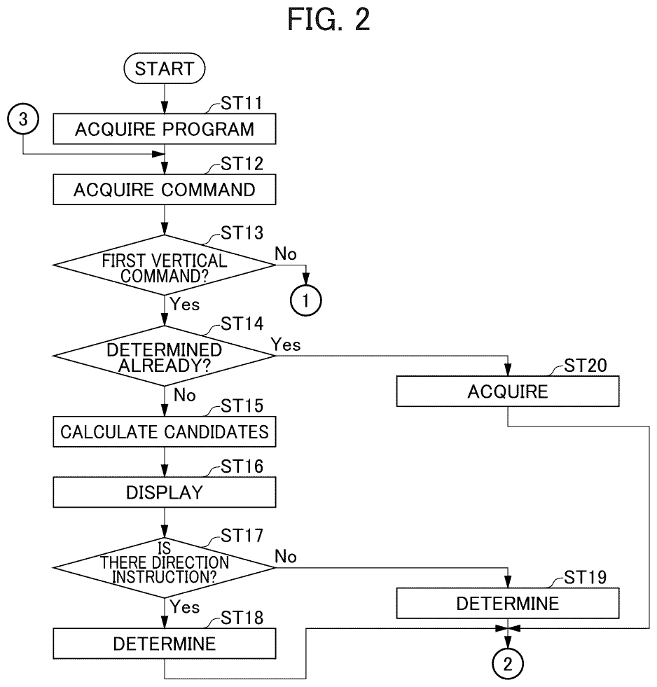

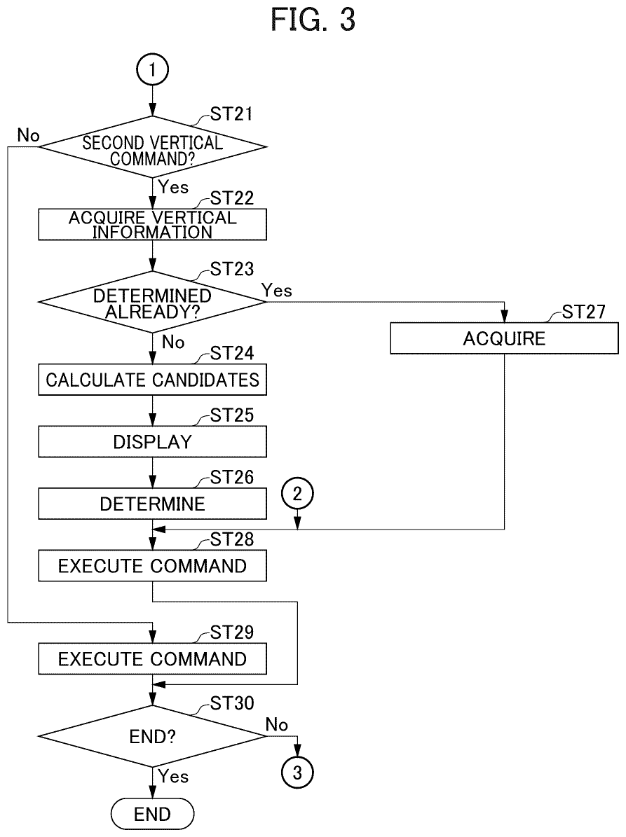

Hereinafter, the operation of the numerical control system 1 according to the embodiment will be described with reference to FIGS. 2 and 3. The details of processing in the following operation descriptions are examples, and various processing that can achieve similar results can be appropriately used. FIGS. 2 and 3 are flowcharts illustrating examples of processing by the processor 110 of the numerical control device 100. The processor 110 executes the processing illustrated in FIGS. 2 and 3, based on programs stored in the ROM 120 or the auxiliary storage device 140, for example.

The processor 110 starts the processing illustrated in FIGS. 2 and 3 when executing an NC program. In Step ST11 illustrated in FIG. 2, the processor 110 of the numerical control device 100 acquires the NC program to be executed (hereinafter referred to as the “target program”) from the auxiliary storage device 140 or the like.

In the description of FIG. 2, the following two NC programs “00001” and “00002” are used as examples. That is, an example is described in which the processor 110 acquires “00001” or “00002” as the target program. The programming language used in the NC program is not limited. The NC program may include a plurality of commands in one line. In the NC program, a single command may span a plurality of lines.
O0001
N1 G54
N2 G90 G00 X0 Y200.0 Z0 B0 C0
N3 G68.2 P1 X-50.0 Y0 Z-80.0 I0 J30.0 K0
N4 G53.1 P1
N5 G43 H1 X0 Y0 Z0
N1 G54
N2 G90 G00 X0 Y200.0 Z0 B0 C0
N3 G68.5 P1
N4 G43 H1 X0 Y0 Z0

In the NC program “00001” and “00002”, the letter N followed by a number indicates the line number. N3 indicates the third line. The NC programs “00001” and “00002” each include one vertical command. A vertical command makes the tool 220 perpendicular to the inclined surface and sets a coordinate system based on the inclined surface. The inclined surface is defined by the vertical command. There are two types of vertical commands: the first vertical command and the second vertical command. The NC program “00001” includes one first vertical command. The NC program “00002” includes one second vertical command.

The first line of the NC programs “00001” and “00002” is a command to determine the initial state coordinate system, namely the X1Y1Z1 coordinate system.

The second line of the NC programs “00001” and “00002” is a command to move the tool 220 of the industrial machinery 200.

The third line of the NC program “00001” is a command to define the position and angle of the inclined surface 301 of the workpiece 300.

The fourth line of the NC program “00001” is the first vertical command. In the NC program “00001”, the first vertical command in the fourth line makes the tool 220 perpendicular to the inclined surface 301 defined in the third line. The first vertical command may include instructions indicating the direction in which the rotational axis should rotate (hereinafter referred to as “direction instructions”). In the first vertical command in the fourth line of the NC program “00001”, the portion “P1” is the direction instruction. The direction instruction “P1” indicates rotating the rotational axis 231 in the positive direction (B-axis in the positive direction). Direction instructions other than “P1” may include “P-1”, “P2”, and “P-2”. The direction instruction “P-1” indicates rotating the rotational axis 231 in the negative direction. The direction instruction “P2” indicates rotating the rotational axis 232 in the positive direction (C-axis in the positive direction). The direction instruction “P-2” indicates rotating the rotational axis 232 in the negative direction. The first vertical command may include a plurality of direction instructions. The number of direction instructions in this case is at least two and no more than the number of rotational axes. For example, the direction instruction “P1P2” includes the direction instructions “P1” and “P2”. In other words, the direction instruction “P1P2” indicates rotating the rotational axis 231 in the positive direction and rotating the rotational axis 232 in the positive direction.

The third line of the NC program “00002” is the second vertical command. The second vertical command acquires the position and angle of the inclined surface 301 of the workpiece 300 and the direction instructions by referring to the external part of the NC program “00002”. The external part is, for example, a file different from the file containing the NC program “00002”. Alternatively, the external part may be a part other than the NC program “00002” in the file containing the NC program “00002”. The “P1” in the second vertical command in the third line of the NC program “00002” indicates the referenced information.

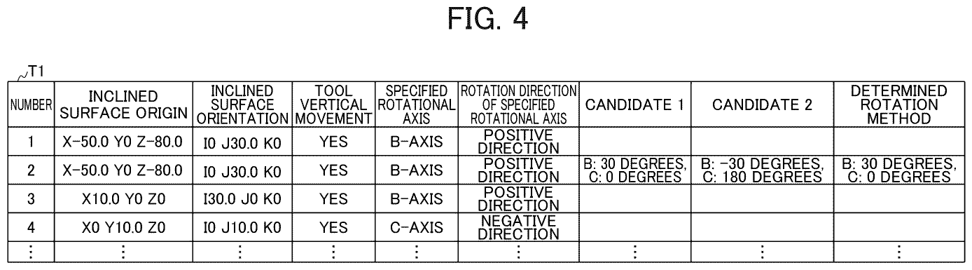

FIG. 4 is a diagram illustrating an example of a table T1 referenced by the second vertical command. The table T1 is an example of the inclined surface information table 141. The table T1 stores vertical information. The vertical information includes, for example, the position and angle of the inclined surface 301 and the direction instructions. The vertical information may include the candidate angle combinations and the determined rotation methods. The table T1 stores one vertical information per row, for example. As an example, the table T1 includes a number, an inclined surface origin, an inclined surface orientation, a tool vertical movement, a specified rotational axis and a rotation direction of the specified rotational axis, candidate 1, candidate 2, and the determined rotation method.

The number in the table T1 is unique identification information assigned to each combination of the position and angle of the inclined surface 301 and the direction instructions. The inclined surface origin indicates the position of the inclined surface 301. The inclined surface orientation indicates the angle of the inclined surface 301. The tool vertical movement indicates whether the tool 220 is made perpendicular to the inclined surface. The specified rotational axis and the rotation direction of the specified rotational axis indicate the direction instructions. The specified rotational axis indicates which rotational axis is targeted for the direction instructions. The rotation direction of the specified rotational axis may be targeted for the direction instructions, or each row of the table T1 may include a plurality of direction instructions. The number of direction instructions in this case is at least two and no more than the number of rotational axes. In a case where the table T1 includes two direction instructions, for example, the table T1 includes the specified rotational axis 1 and the rotation direction 1 of the specified rotational axis, as well as the specified rotational axis 2 and rotation direction 2 of the specified rotational axis. The specified rotational axis 1 and rotation direction 1 of the specified rotational axis are one direction instruction, and the specified rotational axis 2 and rotation direction 2 of the specified rotational axis are another direction instruction, together making two direction instructions.

The candidate 1 and the candidate 2 each indicate a candidate angle combination described later. The number of candidates included in the vertical information is not limited to two. The determined rotation method indicates the rotation method determined by the processing described later.

The table T1 is created before executing the NC program, for example. The reference destination of the second vertical command may be other than a table. In this case, the reference destination stores the position and angle of the inclined surface 301 of the workpiece 300 and the direction instructions in a format other than a table.

“Pn” in the second vertical command indicates, for example, which position of the table T1 to reference. n is, for example, an integer of 1 or more.

“Pn” in the second vertical command indicates, for example, referencing the nth row of the table T1. For example, in a case where n=1, “P1” in the second vertical command indicates referencing the first row of the table T1.

In Step ST12, the processor 110 acquires the next command to be executed from the target program. The command last acquired in Step ST12 is hereinafter referred to as the “acquired command”.

In Step ST13, the processor 110 determines whether the acquired command is the first vertical command. If the acquired command is the first vertical command, the processor 110 determines “Yes” in Step ST13 and proceeds to Step ST14.

In Step ST14, the processor 110 determines whether the rotation method for executing the acquired command has already been determined. If the rotation method has been determined, the processor 110 determines “No” in Step ST14 and proceeds to Step ST15. Details of the rotation method will be described later.

In Step ST15, the processor 110 calculates the angle combinations, based on the inclined surface defined by the first vertical command. The “angle combination” refers to “the combination of angles of each rotational axis to make the tool perpendicular to the inclined surface”. For the NC program “00001”, this is defined in the third line. The angle combination calculated here is a candidate for the angle combination used in the control of the industrial machinery 200. If there are two rotational axes capable of changing the orientation of the tool 220, there are usually two candidates. However, depending on the range of rotation of each rotational axis, there may be fewer than two candidates. In cases where there are three or more rotational axes, the processor 110 may limit the calculated combinations to those satisfying predetermined conditions.

By executing the processing in Step ST15, the processor 110 functions as an example of a calculation unit that calculates one or more angle combinations for a plurality of rotational axes that can change the orientation of the tool, such that the tool forms a predetermined angle with a plane.

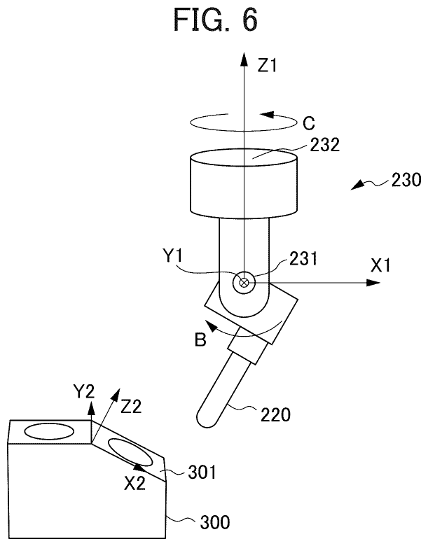

FIGS. 5 and 6 illustrate examples of two angle combination candidates. FIG. 6 is a diagram illustrating a second example of the state of the tool 220 and the spindle 230 when the tool 220 is made perpendicular to the inclined surface 301 of the workpiece 300.

The inclined surface 301 illustrated in FIGS. 5 and 6 is inclined by −30 degrees with respect to the X1 axis. The inclined surface 301 is parallel to the Y1 axis. The X1Y1Z1 coordinate system is the initial coordinate system before making the tool 220 perpendicular to the inclined surface. The X2Y2Z2 coordinate system is the coordinate system after making the tool 220 perpendicular to the inclined surface 301. That is, in the X2Y2Z2 coordinate system, the inclined surface 301 is parallel to the X2Y2 plane. Preferably, the inclined surface 301 coincides with the X2Y2 plane.

In the first example illustrated in FIG. 5, the angle of the rotational axis 231 is 30 degrees, and the angle of the rotational axis 232 is 0 degrees. In the second example illustrated in FIG. 6, the angle of the rotational axis 231 is −30 degrees, and the angle of the rotational axis 232 is 180 degrees.

In Step ST16, the processor 110 displays images indicating the angle combinations calculated in Step ST15 on the display device 160 or the like. For example, the processor 110 displays images illustrating the same content as FIGS. 5 and 6. Alternatively, the processor 110 displays images indicating the angle combinations calculated in Step ST15 in text form or the like.

By executing the processing in Step ST16 in cooperation with the display device 160, the processor 110 functions as an example of a display unit that displays images indicating combinations.

In Step ST17, the processor 110 determines whether the acquired command includes a direction instruction. If the acquired command includes a direction instruction, the processor 110 determines “Yes” in Step ST17 and proceeds to Step ST18.

In Step ST18, the processor 110 determines the rotation method for making the tool perpendicular to the inclined surface in accordance with the direction instruction in the acquired command. The rotation method includes the rotation direction and the rotation angle. The processor 110 determines the rotation method such that the movement amount is minimized. However, if the rotation method has already been determined, the processor 110 may acquire the determined rotation method instead of determining the rotation method.

The following case is considered as an example.

Angle of the rotational axis 231: 0 degrees

Angle of the rotational axis 232: 0 degrees

Direction instruction included in the acquired command: Rotate the rotational axis 231 in the positive direction (P1).

Inclined surface 301: Inclined at 30 degrees relative to the X1 axis and parallel to the Y1 axis (same as the inclined surface 301 illustrated in FIGS. 5 and 6).

In order to change this state to the state of the first example, the rotational axis 231 should be rotated 30 degrees in the positive direction. No rotation is required for the rotational axis 232. In order to change this state to the state of the second example, the rotational axis 231 should be rotated 330 degrees in the positive direction and the rotational axis 232 should be rotated 180 degrees in the positive or negative direction.

Rotating the rotational axis 231 30 degrees in the positive direction results in the smallest movement amount. Therefore, the rotation method with the smallest movement amount is as follows:

Rotational axis 231: Rotate 30 degrees in the positive direction.

Rotational axis 232: Rotate 0 degrees (do not rotate), direction does not matter.

The movement amount is determined by, for example, the following (i) or (ii):
(i) The sum of the rotation angles of each rotational axis.
(ii) The largest rotation angle among the rotation angles of each rotational axis.

The following case is considered as another example:
Angle of the rotational axis 231: 0 degrees
Angle of the rotational axis 232: 0 degrees
Direction instruction included in the acquired command: Rotate the rotational axis 231 in the negative direction (P-1).
Inclined surface 301: Parallel to the X1 axis and inclined 20 degrees relative to the Y1 axis.

In this case, there are two angle combinations: a combination A1 (angle of the rotational axis 231 is 20 degrees, angle of the rotational axis 232 is 90 degrees); and a combination A2 (angle of the rotational axis 231 is −20 degrees, angle of the rotational axis 232 is −90 degrees).

In order to achieve the state of combination A1, the rotational axis 231 should be rotated 340 degrees in the negative direction, and the rotational axis 232 should be rotated 90 degrees in the positive direction. Rotating the rotational axis 232 270 degrees in the negative direction also results in the state of combination A1; however, this involves a larger movement amount than the case of rotating 90 degrees in the positive direction and is therefore unsuitable. In order to achieve the state of combination A2, the rotational axis 231 should be rotated 20 degrees in the negative direction and the rotational axis 232 should be rotated 90 degrees in the negative direction.

Rotating the rotational axis 231 20 degrees in the negative direction and the rotational axis 232 90 degrees in the negative direction results in the smallest movement amount. Therefore, the rotation method with the smallest movement amount is as follows:
Rotational axis 231: Rotate 20 degrees in the negative direction. Rotational axis 232: Rotate 90 degrees in the negative direction.

On the other hand, if the acquired command does not include a direction instruction, the processor 110 determines “No” in Step ST17 and proceeds to Step ST19.

The processor 110 stores the determined rotation method in association with the target program and the acquired command. The rotation method stored here is the determined rotation method.

For example, the direction position selection unit 112 executes the processing of Step ST18.

By executing the processing in Step ST18, the processor 110 functions as an example of a determination unit that determines a direction and an angle by which each of the plurality of rotational axes is rotated such that the plurality of rotational axes achieve any one of the angle combinations calculated by the calculation unit, in accordance with an instruction indicating a direction by which at least one of the rotational axes is rotated such that a movement amount or movement time of rotation of the rotational axes is minimized.

In Step ST19, the processor 110 determines the rotation method for making the tool perpendicular to the inclined surface. The processor 110 determines the rotation method that minimizes the movement amount. The rotation method determined in Step ST19 differs from that in Step ST18, allowing any direction for the rotation of any of the rotational axes. For example, the position selection unit 113 executes the processing of Step ST19.

If the rotation method has already been determined, the processor 110 determines “Yes” in Step ST14 and proceeds to Step ST20.

In Step ST20, the processor 110 acquires the determined rotation method. The rotation method is the one stored in the processing of Step ST18 during the execution of the target program in a previous run.

If the acquired command is not the first vertical command, the processor 110 determines “No” in Step ST13 and proceeds to Step ST21 illustrated in FIG. 3.

In Step ST21, the processor 110 determines whether the acquired command is the second vertical command. If the acquired command is the second vertical command, the processor 110 determines “Yes” in Step ST21 and proceeds to Step ST22.

In Step ST22, the processor 110 acquires the vertical information specified by the acquired command. That is, the processor 110 acquires the vertical information from the reference destination, based on the information indicating the reference destination included in the second vertical command.

The inclined surface orientation in the vertical information is an example of the angle of the plane. By executing the processing in Step ST22, the processor 110 functions as an example of an acquisition unit that acquires a predetermined angle and instructions from the table.

In Step ST23, the processor 110 determines whether the rotation method for executing the acquired command has already been determined. For example, if the vertical information acquired in Step ST22 includes the determined rotation method, the processor 110 determines that the rotation method has been determined. If the rotation method has not been determined, the processor 110 determines “No” in Step ST23 and proceeds to Step ST24.

In Step ST24, the processor 110 calculates candidate angle combinations, based on the inclined surface origin and the inclined surface orientation in the vertical information acquired in Step ST22. The processor 110 writes the calculated angle combinations to the reference destination included in the second vertical command. For example, the processor 110 writes the calculated angle combinations to the candidates 1 and 2 in the referenced row of the table T1.

Thus, by executing the processing of Step ST24, the processor 110 functions as an example of a calculation unit that calculates one or more angle combinations for the plurality of rotational axes capable of changing the orientation of the tool to form a predetermined angle with a plane.

In Step ST25, the processor 110 displays images indicating the angle combinations calculated in Step ST24 on the display device 160 or the like. For example, the processor 110 displays images illustrating the same content as FIGS. 5 and 6. Alternatively, the processor 110 displays images indicating the angle combinations calculated in Step ST24 in text form or the like.

By executing the processing in Step ST25 in cooperation with the display device 160, the processor 110 functions as an example of a display unit that displays images indicating combinations.

In Step ST26, the processor 110 determines the rotation method for making the tool perpendicular to the inclined surface in accordance with the direction instructions in the vertical information acquired in Step ST22. The processor 110 determines the rotation method in the same manner as in Step ST18, for example.

The processor 110 writes the determined rotation method to the reference destination included in the second vertical command. In the table T1, the row with number 2 is the row with the determined rotation method written.

By executing the processing in Step ST26, the processor 110 functions as an example of a determination unit that determines a direction and an angle by which each of the plurality of rotational axes is rotated such that the plurality of rotational axes achieve any one of the angle combinations calculated by the calculation unit, in accordance with an instruction indicating a direction by which at least one of the rotational axes is rotated such that a movement amount or movement time of rotation of the rotational axes is minimized.

If the rotation method has already been determined, the processor 110 determines “Yes” in Step ST23 and proceeds to Step ST27.

In Step ST27, the processor 110 acquires the determined rotation method from the vertical information acquired in Step ST22.

After the processing of Step ST18, Step ST19, Step ST20 in FIG. 2, or Step ST26 or Step ST27 in FIG. 3, the processor 110 proceeds to Step ST28.

In Step ST28, the processor 110 executes the acquired vertical command. If the processing in Step ST18, Step ST19 of FIG. 2, or Steps ST26 to ST28 of FIG. 3 has been completed, the processor 110 executes the vertical command by rotating each rotational axis using the rotation method determined in Step ST18, Step ST19 of FIG. 2, or Step ST26 of FIG. 3. If the processing in Step ST20 of FIG. 2 or Steps ST27 to ST28 of FIG. 3 has been completed, the processor 110 executes the vertical command by rotating each rotational axis using the rotation method acquired in Step ST20 of FIG. 2 or Step ST27 of FIG. 3.

If the acquired command is not the second vertical command, the processor 110 determines “No” in Step ST21 and proceeds to Step ST29. In Step ST29, the processor 110 executes the acquired command.

In Step ST30, the processor 110 determines whether to end the execution of the target program. For example, if there are no more commands to be executed following the acquired command, the processor 110 determines to end the execution of the target program. Alternatively, if the command to be executed next is a command indicating the termination of the program, the processor 110 determines to end the execution of the target program. If the execution of the target program is not ended, the processor 110 determines “No” in Step ST30 and returns to Step ST12 illustrated in FIG. 2. Conversely, if the execution of the target program is ended, the processor 110 determines “Yes” in Step ST30 and terminates the processing illustrated in FIGS. 2 and 3.

According to the numerical control system 1 of the embodiment, the numerical control device 100 rotates the rotational axes in the direction instructed in the direction instruction in the vertical command, thereby making the tool perpendicular to the inclined surface. The creator of the NC program can instruct the rotation direction of the rotational axes to the numerical control device 100 when making the tool perpendicular to the inclined surface by including a direction instruction in the NC program or the table T1. As a result, the creator of the NC program can prevent the tool 220 from interfering with the workpiece or jig.

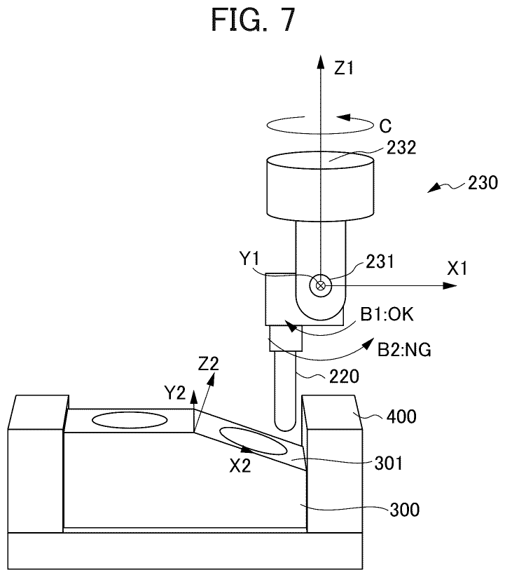

FIG. 7 illustrates an example of the state of the tool 220 and the jig 400. In the state as illustrated in FIG. 7, rotating the rotational axis 231 in the positive direction (B1 direction) does not cause the tool 220 to interfere with the jig 400. However, rotating the rotational axis 231 in the negative direction (B2 direction) causes the tool 220 to interfere with the jig 400. Therefore, the creator of the NC program includes a direction instruction to rotate the rotational axis 231 in the positive direction in the NC program or the table T1. As a result, the numerical control device 100 of the embodiment can execute the vertical command without causing the tool 220 to interfere with the jig 400.

According to the numerical control system 1 of the embodiment, the numerical control device 100 displays the calculated angle combinations on the display device 160. As a result, the operator can confirm the available angle combinations.

According to the numerical control system 1 of the embodiment, the numerical control device 100 can acquire direction instructions from the table T1 or similar sources. Therefore, the numerical control device 100 of the embodiment can receive instructions on the rotation direction of the rotational axis from outside the NC program.

According to the numerical control system 1 of the embodiment, the numerical control device 100 acquires the position and angle of the inclined surface 301 from the table T1 or similar sources. Therefore, the numerical control device 100 of the embodiment can define the position and angle of the inclined surface 301 from outside the NC program.

According to the numerical control system 1 of the embodiment, the numerical control device 100 stores the determined rotation method in the auxiliary storage device 140 or similar storage. As a result, the numerical control device 100 of the embodiment can acquire and use the determined rotation method in the second and subsequent executions of the same NC program, eliminating the need to determine the rotation method again.

The above embodiments can be modified as follows: In the above embodiment, the numerical control device 100 makes the tool 220 perpendicular to the inclined surface 301. However, the numerical control device 100 may use another angle instead of perpendicularity. The other angle is an example of a predetermined angle.

Instead of movement amount, movement time may be used. The movement time can be calculated, for example, using (iii) or (iv) below:

$$The sum of ( ( rotation angle ) \div ( rotation speed ) ) for each rotational axis . \qquad ( iii )$$

$$The longest time among ( ( rotation angle ) \div ( rotation speed ) ) for each rotational axis . \qquad ( iv )$$

The processor 110 may implement some or all of the processing implemented by the program in the above embodiments by way of the hardware configuration of the circuit.

The program for implementing the processing of the embodiments may be transferred in a state stored on a non-transitory recording medium in the device, for example. However, the device may be transferred without the program stored. The program may be transferred separately and written to the device. The transfer of the program may be implemented, for example, by recording on a removable non-transitory recording medium or by downloading via a network such as the Internet or LAN (local area network).

The embodiments of the present invention described above are presented as examples and do not limit the scope of the present invention. The embodiments of the present invention can be implemented in various forms without departing from the spirit of the present invention.

### EXPLANATION OF REFERENCE NUMERALS

1: numerical control system
100: numerical control device
110: processor
111: program analysis unit
112: direction position selection unit
113: position selection unit
114: movement control unit
120: ROM
130: RAM
140: auxiliary storage device
141: inclined surface information table
150, 210: input device
160: display device
170: control interface
180: bus
200: industrial machinery
220: tool
230: main spindle
231, 232: rotational axis

1. A processing device, comprising:
a calculation unit that calculates one or more angle combinations for a plurality of rotational axes capable of changing an orientation of a tool such that the tool forms a predetermined angle with a plane; and
a determination unit that determines a direction and an angle by which each of the plurality of rotational axes is rotated such that the plurality of rotational axes achieve any one of the angle combinations calculated by the calculation unit, in accordance with an instruction indicating a direction by which at least one of the rotational axes is rotated such that a movement amount or movement time of rotation of the rotational axes is minimized.

2. The processing device according to claim 1, further comprising a display unit that displays an image indicating the angle combinations.

3. The processing device according to claim 1, further comprising an acquisition unit that acquires an angle of the plane and the instruction from a table, wherein
the calculation unit calculates the angle combinations using the angle of the plane acquired from the table, and
the determination unit determines the direction and the angle by which each of the plurality of rotational axes is rotated using the instruction acquired from the table.

4. The processing device according to claim 1, further comprising a storage unit that stores information indicating the direction and the angle by which each of the plurality of rotational axes is rotated, the information having been determined by the determination unit.

5. A non-transitory computer-readable storage medium storing a program that is executed by a computer that comprises a processor of a processing device, the program being executable to cause the computer to perform operations comprising:
calculating one or more angle combinations for a plurality of rotational axes capable of changing an orientation of a tool such that the tool forms a predetermined angle with a plane; and
determining a direction and an angle by which each of the plurality of rotational axes is rotated such that the plurality of rotational axes achieve any one of the angle combinations, in accordance with an instruction indicating a direction by which at least one of the rotational axes is rotated such that a movement amount or movement time of rotation of the rotational axes is minimized.

6. A processing method, comprising:
calculating one or more angle combinations for a plurality of rotational axes capable of changing an orientation of a tool such that the tool forms a predetermined angle with a plane; and
determining a direction and an angle by which each of the plurality of rotational axes is rotated such that the plurality of rotational axes achieve any one of the angle combinations calculated, in accordance with an instruction indicating a direction by which at least one of the rotational axes is rotated such that a movement amount or movement time of rotation of the rotational axes is minimized.
